(19) United States
(12) Patent Application Publication
(10) Pub. No.: US 2015/0054771 A1
(43) Pub. Date: Feb. 26, 2015

(54) TOUCH PANEL CAPACITIVE SENSOR AND ELECTRODE THEREOF

(71) Applicant: J TOUCH CORPORATION, Taoyuan County (TW)

(72) Inventors: YU-CHOU YEH, TAOYUAN COUNTY (TW); TING-CHING LIN, TAOYUAN COUNTY (TW); KUN-MING CHANG, TAOYUAN COUNTY (TW); YI-CHIN CHEN, TAOYUAN COUNTY (TW)

(73) Assignee: J TOUCH CORPORATION, Taoyuan County (TW)

(21) Appl. No.: 13/973,014

(22) Filed: Aug. 22, 2013

(51) Int. Cl. G06F 3/044

(52) U.S. Cl. CPC G06F 3/044
USPC 345/174

(57) ABSTRACT

An electrode of capacitive touch panel sensor includes a plurality of conductive portions, the conductive portions forming a mesh structure. Each of the conductive portions has four curved wires defining a closed region, and each opposite pair of the curved wires has the same opening orientation.

### BACKGROUND OF THE INVENTION

1. Field of the Invention

The instant disclosure relates to a capacitive sensor and electrode thereof; in particular, to a touch panel capacitive sensor and electrode thereof.

2. Description of Related Art

Touch panel is widely used in mobile phones, personal digital assistant (PDA), tablet and the like. Capacitive touch panel senses input signal by a two-dimensional sensing structure on a substrate.

Specifically, please refer to FIG. 1 a partially enlarged view of a sensing electrode of a touch panel. The sensing electrode 50 includes a plurality of parallel first straight wires 51 and a plurality of parallel second straight wires 52. The first straight wires 51 go along a first direction while the second straight wires 52 go along a second direction. The first and second directions meet at points. In other words, the first straight wires 51 and the second straight wires 52 are superimposed and formed a plurality of intersections 512.

The touch panel is assembled on a display panel. If the first and second straight wires 51, 52 are metal wires, the light emitting from the backlight of the display panel may be easily interfered around the intersection 512. As a result, glare and moiré may occur, and the screen display quality is negatively affected.

### BRIEF SUMMARY OF THE INVENTION

The instant disclosure provides a touch panel capacitive sensor and electrode thereof. Curved wires are employed to replace the conventional straight wires.

According to one embodiment of the instant disclosure, the touch panel electrode includes a plurality of conductive portions, the conductive portions forming a mesh structure. Each of the conductive portions has four curved wires defining a closed region, and each opposite pair of the curved wires has the same opening orientation.

According to another embodiment of the instant disclosure, a touch panel capacitive sensor is provided. The touch panel capacitive sensor includes a first electrode and a second electrode. The first electrode includes a plurality of first conductive portions forming a mesh structure. Each of the first conductive portions has four first curved wires. The four first curved wires collectively define a first closed region, and each opposite pair of the first curved wires has the same opening orientation. The second electrode includes a plurality of second conductive portions forming a mesh structure. Each of the second conductive portions has four second curved wires. The four second curved wires define a second closed region, and each opposite pair of the second curved wires has the same opening orientation. The first and second electrodes are electrically insulated to each other. Each first curved wire of the first conductive portions and one second curved wire of the second conductive portions meet at one point.

Compared to the conventional electrode employing straight and metal wires, the curved wires of the instant disclosure reduce the occurrence of glare and moiré. Therefore, the image visibility and quality are greatly enhanced.

In order to further understand the instant disclosure, the following embodiments are provided along with illustrations to facilitate the appreciation of the instant disclosure; however, the appended drawings are merely provided for reference and illustration, without any intention to be used for limiting the scope of the instant disclosure.

### BRIEF DESCRIPTION OF THE SEVERAL VIEWS OF THE DRAWINGS

FIG. 1 shows a conventional touch panel sensing electrode.

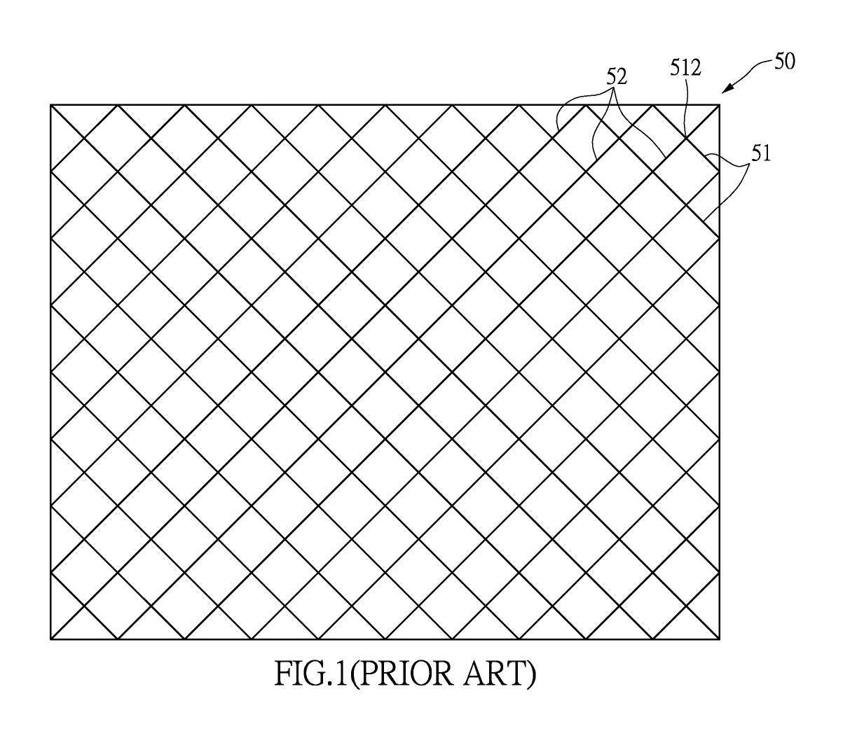

FIG. 2 shows a partial schematic diagram of an electrode in accordance with an embodiment of the instant disclosure;

FIG. 3 shows a partially perspective view of a touch panel capacitive sensor in accordance with an embodiment of the instant disclosure;

FIG. 4 shows a partial schematic diagram of an electrode in accordance with another embodiment of the instant disclosure;

FIG. 5 shows a partial schematic diagram of an electrode in accordance with another embodiment of the instant disclosure; and

FIG. 6 shows a partial schematic diagram of an electrode in accordance with another embodiment of the instant disclosure.

### DETAILED DESCRIPTION OF THE INVENTION

The aforementioned illustrations and following detailed descriptions are exemplary for the purpose of further explaining the scope of the instant disclosure. Other objectives and advantages related to the instant disclosure will be illustrated in the subsequent descriptions and appended drawings.

According to an embodiment of the instant disclosure, a capacitive touch panel is provided. The capacitive touch panel identifies a contacting point when an electrical current is generated by the capacitive change between an electrode and the electrostatic of an object. The capacitive touch panel has a capacitive sensor. The capacitive sensors includes a substrate and two capacitive sensing layer formed on opposite sides of the substrate. Specifically, visible and invisible areas are defined on the substrate. The capacitive sensor is disposed in the visible area, and the capacitive sensing layer has electrodes along an X axis and electrodes along a Y axis. The X axis electrodes and Y axis electrodes are connected to a routing in the invisible area.

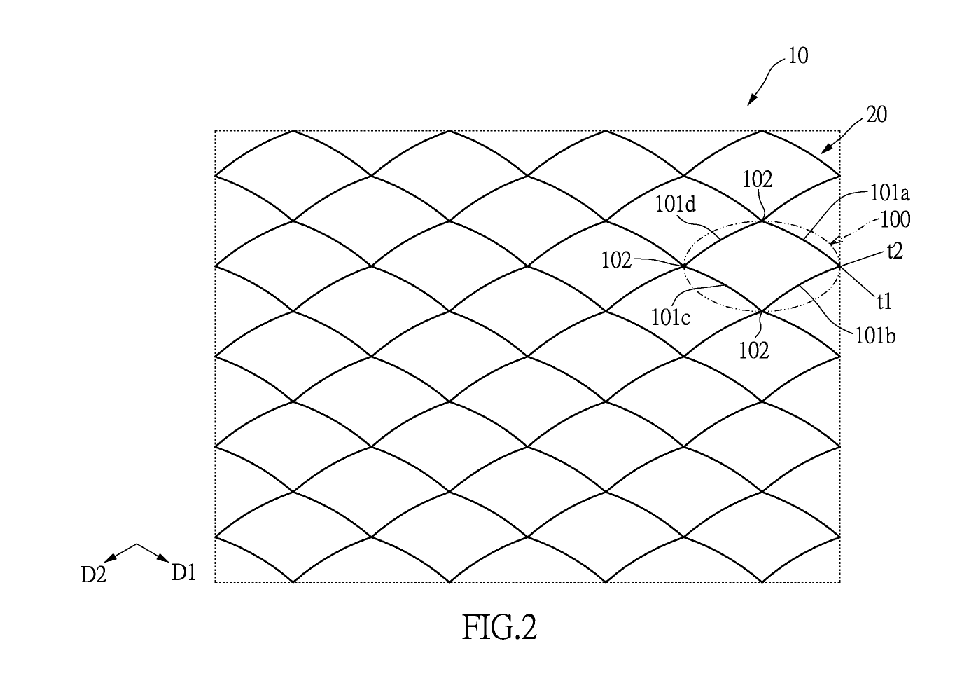

Please refer to FIG. 2 showing a partial schematic view of the electrode in accordance with an embodiment of the instant disclosure. In the instant embodiment, a touch panel electrode 10 is formed on a transparent substrate 20. The electrode 10 resembles a mesh structure and includes a plurality of conductive portions 100. Each conductive portion 100 has four curved wires 101a, 101b, 101c and 101d. The four curved wires 101a, 101b, 101c and 101d define a closed region. Each of the curved wires 101a, 101b, 101c and 101d has a width ranges between 3 μm to 8 μm. If the width of the curved wires is too narrow, the conductivity of the conductive portions 100 is compromised. In terms of touch panel, the sensitivity is reduced. If the width of the curved wires is too broad, it is likely to have moiré and the display quality is reduced.

Specifically, the four curved wires 101a, 101b, 101c and 101d are arranged in a specific orientation. Two curved wires 101a, 101c are opposite each other, and the other two curved wires 101b, 101d are opposite each other. The curved wires 101a, 101c open toward a first direction D1. Likewise, the other pair 101b, 101d open toward a second direction D2. The first and second directions D1, D2 meet at a point, and the angle formed thereby ranges may be 90 degree or the others. In addition, as shown in figure, the two immediately adjacent curved wires 101a, 101d meet and form an intersection point 102.

In the instant embodiment, the curved wires 101a, 101b, 101c and 101d may be made of metallic material. When the dimension of the touch panel is relatively large, the adaption of metallic curved wires can reduce the cost. Additionally, metal has better conductivity compared to transparent conductive oxides, and therefore the touch panel may have higher sensitivity upon contacting an object. When the curved wires 101a, 101b, 101c and 101d are made of metal, the metallic material is selected from the group consisting of cupper, silver, aluminum, molybdenum, nickel, chromium, titanium, silicon, tin, zinc, stainless steel, tungsten and the alloy thereof. In another embodiment, the curved wires 101a, 101b, 101c and 101d may also be made of transparent conductive oxides.

In another embodiment, curved wire 101a has a first cutting direction t1 at the intersection point 102 while the curved wire 101b adjacent to the curved wire 101a has a second cutting direction t2 at the intersection point 102. The first and second cutting directions t1, t2 meet, and the sharp angle formed thereby ranges between 60 to 80 degrees. By limiting the sharp angle in the specified range, it is proved to effectively attenuate moiré. Furthermore, the size of the sharp angle has influence on the opening rate of the electrode. The opening rate refers to the ratio between the light permeable portions that exclude the conductive portions to the entire touch panel. When the touch panel is implemented to a display device, the opening rate affects the brightness of the display device.

When the touch panel having the abovementioned electrode is assembled to the display panel, light rays reflect and diffract along the cutting directions of the curved wires 101a, 101b, 101c and 101d. This phenomenon arises because the conductive portions 100 are formed by curved wires 101a, 101b, 101c and 101d instead of the conventional straight wires. As a result, the diffracted light rays hardly interfere at the intersection point 102, and glare as well as moiré is minimized.

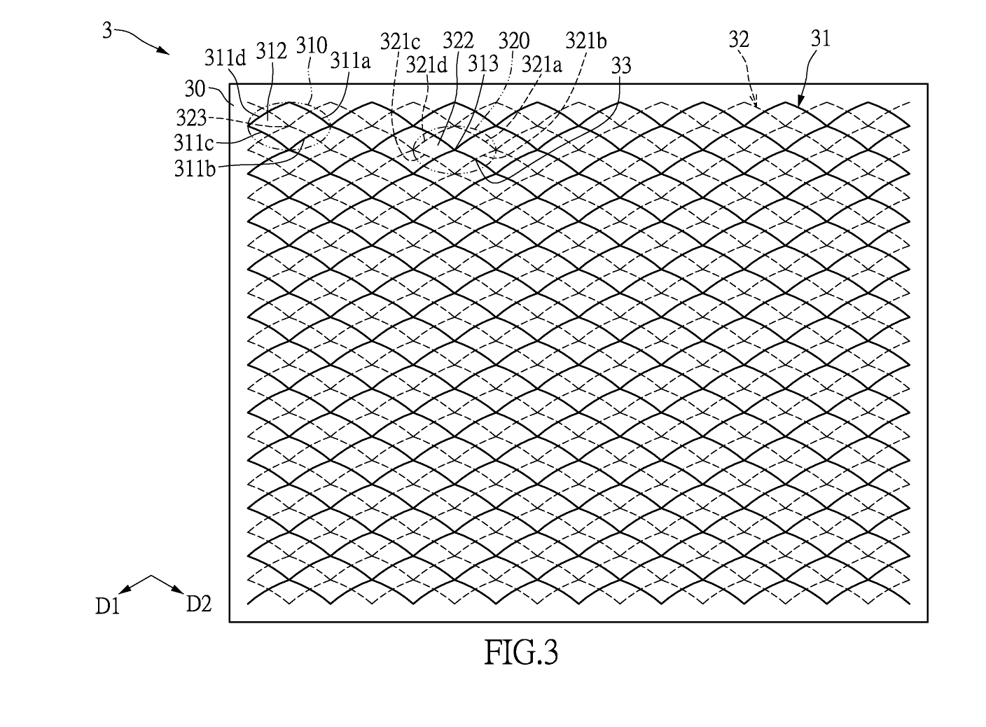

Please refer to FIG. 3 showing a partially perspective view of the touch panel capacitive sensor in accordance with an embodiment of the instant disclosure. The capacitive sensor 3 includes a transparent substrate 30, a first electrode 31 (as shown in solid lines) and a second electrode 32 (as shown in dotted lines). It is worth noting that the visible and invisible areas are defined on the transparent substrate 30, and the first and second electrodes 31, 32 are disposed on the visible area.

The transparent substrate 30 is made of insulation material, for example, plastic film, plastic plate or glass plate. The plastic film or plastic plate is made of the material selected from one of the group consisting of acrylate, polyethylene terephthalate (PET), polyethylene naphthalate (PEN), polyethene (PE), polypropene (PP), polystyrene (PS), ethylene vinyl acetate (EVA), polycarbonate (PC), polyamide, polyimide, resin and triacetyl cellulose (TAC).

In the instant embodiment, the first and second electrodes 31, 32 are electrically insulated to each other and are disposed on the transparent substrate 30. Specifically, the transparent substrate 30 has a top face and a bottom face opposite the top face. The first electrode 31 is formed on the top face whereas the second electrode 32 is formed on the bottom face. That is to say, the first electrode 31 goes along an X axis on the top face of the substrate 30 whereas the second electrode 32 goes along a Y axis on the bottom face of the substrate 30. The electrodes going along the X and Y axes are electrically connected to the wires on a routing area (not shown). The first and second electrodes 31, 32 shown in FIG. 3 represent part of the X and Y electrodes. In another embodiment, the first and second electrodes 31, 32 may be disposed on different transparent substrates 30.

In the instant embodiment, the first and second electrodes 31, 32 adopt the electrode layout as shown in FIG. 2. More specifically, the first electrode 31 still resembles a mesh structure and has a plurality of first conductive portions 310. Each first conductive portion 310 has four first curved wires 311a, 311b, 311c and 311d. The four first curved wires 311a, 311b, 311c and 311d define a first closed region 312. The four first curved wires 311a, 311b, 311c and 311d are arranged in a specific orientation. Two first curved wires 311a, 311c are opposite each other, and the other two first curved wires 311b, 311d are opposite each other. The two opposite first curved wires 311a, 311c open toward the same direction, the first direction D1. Likewise, the other pair 311b, 311d open toward the same direction, the second direction D2. In other words, the immediately adjacent first curved wires 311a, 311b open toward different directions.

In the instant embodiment, the first curved wires 311a, 311b, 311c and 311d have the same length. However, in another embodiment, the length of the two adjacent first curved wires 311a, 311b may be different according to design requirement. Moreover, the radius of curvature of the two opposite first curved wires 311a, 311c (or 311b, 311d) may vary as well.

The first curved wire 311a and the adjacent first curved wire 311b meet and form a first intersection point 313. The sharp angle formed at the intersection point 313 of the first curved wires 311a, 311b ranges between 60 to 80 degrees.

The second electrode 32 is structurally similar to the first electrode 31. Likewise, the second electrode 32 has a plurality of second conductive portions 320. Each second conductive portion 320 has two second curved wires 321a, 321c which are opposite each other, and other two second curved wires 321b, 321d which are opposite each other. The second curved wires 321a, 321b, 321c and 321d define a second closed region 322. The two opposite second curved wires 311a, 311c open toward the first direction D1 while the other pair 311b, 311d open toward the second direction D2. It is worth mentioning that each second curved wires 321a, 321b, 321c and 321d of the second conductive portion 320 meets at one point with one of the first curved wires 311a, 311b, 311c and 311d. The intersection is a touch control point 33 for sensing the position that is touched.

Referring to FIG. 3, two second curved wires 321a, 321b meet at a second intersection 323 whereas the second intersection 323 does not superimpose the first intersection 313. Namely, the second intersection 323 is arranged within the first closed region 312.

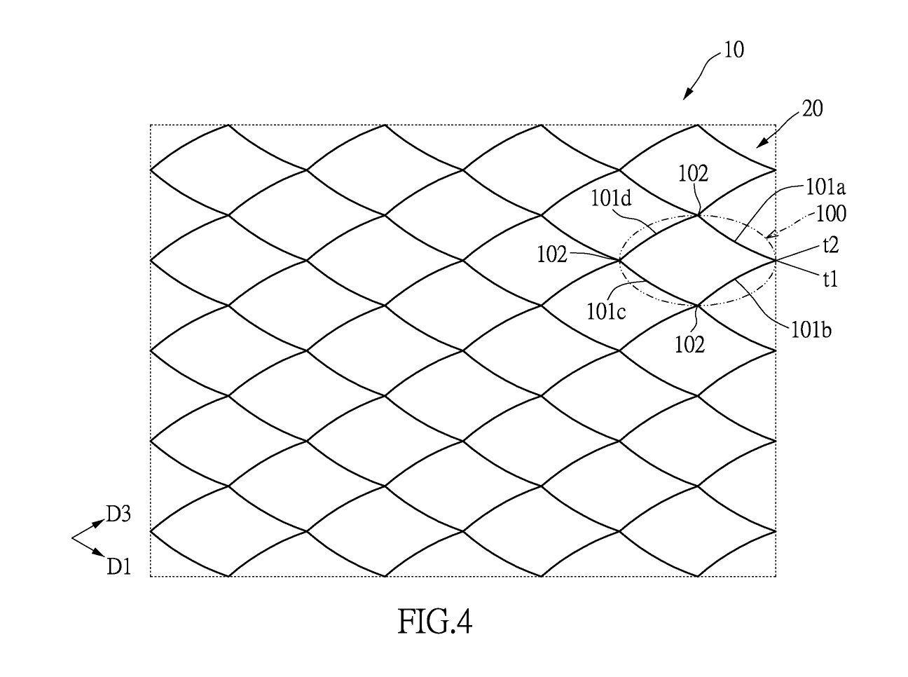

The aforementioned opening orientation does not intend to limit the instant disclosure. Please refer to FIGS. 4-6, showing top views of the electrode in accordance with other embodiments of the instant disclosure. Similar components in these embodiments are not described to avoid redundancy. The electrode 10 in FIG. 4 has four curved wires 101a, 101b, 101c, 101d, and the curved wires open toward different directions from those of the embodiment shown in FIG. 2. For example, the two opposite curved wires 101a, 101c open toward a third direction D3, and the third direction D3 is opposite to the second direction D2.

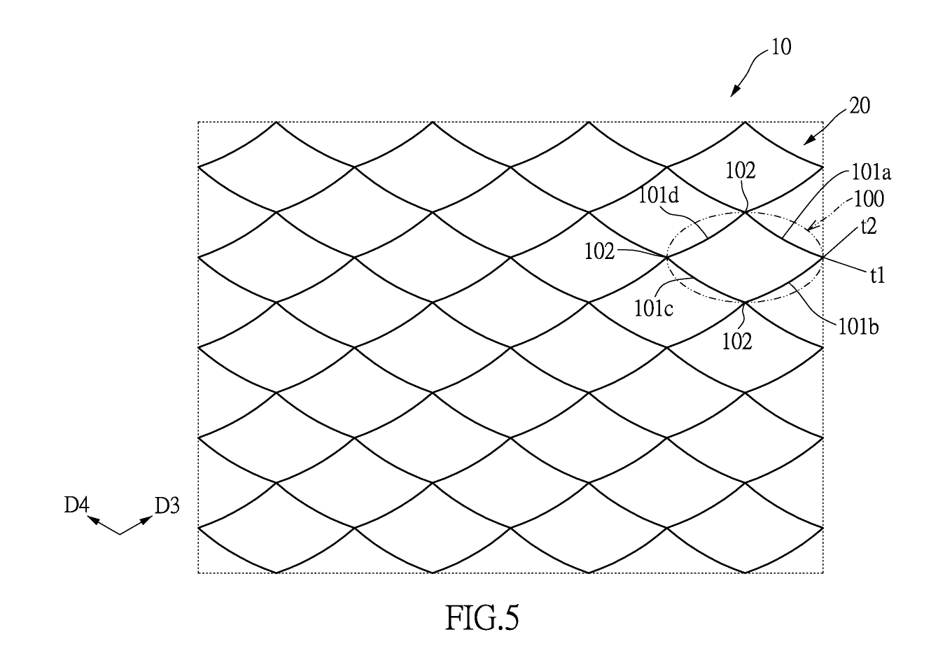

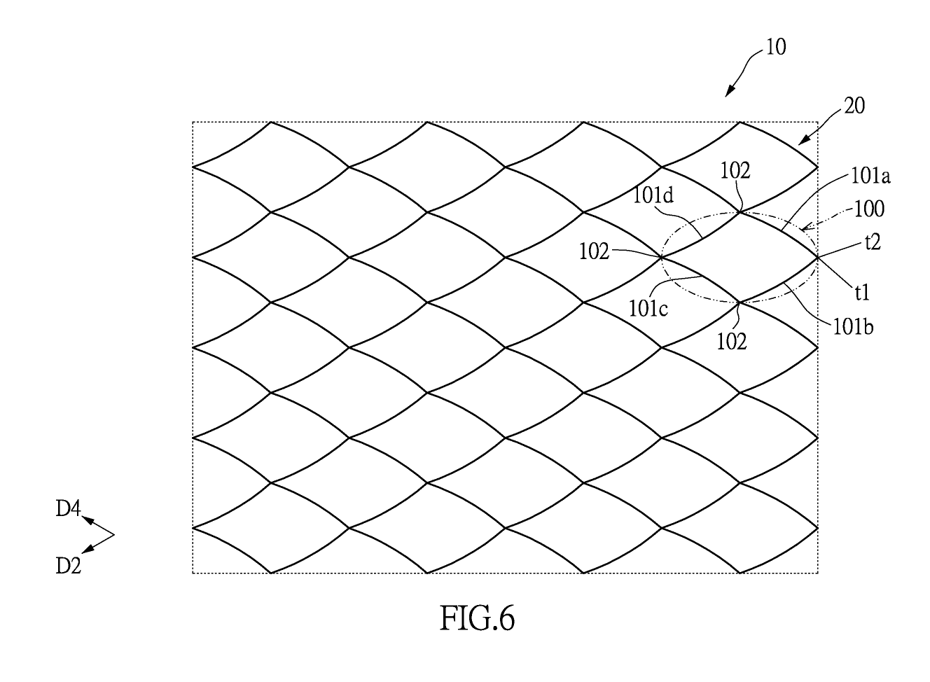

Referring to the embodiment shown in FIG. 5, two opposite first curved wires 101a, 101c of the four curved wires open toward the third direction D3. The other pair of the first curved wires 101b, 101d opens toward a fourth direction D4. The fourth direction D4 is opposite to the first direction D1. In FIG. 6, the two curved wires 101a, 101c open toward the second direction D2 while the other two curved wires 101b, 101d open toward the fourth direction D4. That is to say, as long as the two opposite curved wires open toward substantially the same direction, the opening orientation may have different combination. The first and second electrodes in FIG. 3 may adapt the layout as shown in FIG. 2, 4, 5 or 6.

In short, the electrode of the instant embodiment does not employ the conventional straight wire but the curved wire. The curved design reduces any interference occurring at the intersection point where two adjacent wires meet, therefore inhibiting glare or moiré. In general, the visibility of image and the display quality are both enhanced.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure described by the following claims.

What is claimed is:

1. A touch panel electrode comprising:
a plurality of conductive portions, the conductive portions forming a mesh structure, wherein each of the conductive portions includes four curved wires defining a closed region, and each opposite pair of the curved wires has the same opening orientation.

2. The touch panel electrode according to claim 1, wherein a width of each of the curved wires ranges between 3 μm to 8 μm.

3. The touch panel electrode according to claim 1, wherein two immediately adjacent curved wires meet at an intersection, and a sharp angle formed by two cutting direction of the two immediately adjacent curved wires at the intersection ranges between 60 to 80 degrees.

4. The touch panel electrode according to claim 1, wherein the plurality of curved wires is metal wires.

5. A capacitive touch panel sensor comprising:
a first electrode, the first electrode including a plurality of first conductive portions forming a mesh structure, wherein each of the first conductive portions has four first curved wires, the first curved wires define a first closed region, and each opposite pair of the first curved wires has the same opening orientation; and
a second electrode, the second electrode being electrically insulated to the first electrode and including a plurality of second conductive portions forming a mesh structure, wherein each of the second conductive portions has four second curved wires, the second curved wires define a second closed region, and each opposite pair of the second curved wires has the same opening orientation;
wherein each first curved wire of the first conductive portions and one second curved wire of the second conductive portions meet at only one point.

6. The capacitive touch panel sensor according to claim 5 further comprising a transparent substrate, the transparent substrate having a top face and a bottom face opposite the top face, wherein the first electrode is formed on the top face and the second electrode is formed on the bottom face.

7. The capacitive touch panel sensor according to claim 6, wherein the transparent substrate is a plastic film, a plastic plate or a glass plate.

8. The capacitive touch panel sensor according to claim 5, wherein a width of the first and second curved wires ranges between 3 μm to 8 μm.

9. The capacitive touch panel sensor according to claim 5, wherein the first and second curved wires are metal wires.
